(19) United States
(12) Patent Application Publication
(10) Pub. No.: US 2025/0027879 A1
(43) Pub. Date: Jan. 23, 2025

(54) FLUORESCENCE BIOSENSING SYSTEM AND BIODETECTION METHOD

(71) Applicant: VisEra Technologies Company Ltd., Hsin-Chu City (TW)

(72) Inventor: Hsin-Yi HSIEH, Hsin-Chu City (TW)

(21) Appl. No.: 18/353,318

(22) Filed: Jul. 17, 2023

(51) Int. Cl. G01N 21/64

(52) U.S. Cl. CPC G01N 21/6445; G01N 21/6486

(57) ABSTRACT

The present disclosure provides a fluorescence biosensing system including a sensing device and a light emitting device. The sensing device includes a sensing region, a lower polarizer above the sensing region, a light transmitting element above the lower polarizer, and an upper polarizer above the light transmitting element. The lower polarizer includes a first lower sub-polarizer and a second lower sub-polarizer, and a second polarization direction of the second lower sub-polarizer is 90 degrees shifted from a first polarization direction of the first lower sub-polarizer. The upper polarizer includes a first upper sub-polarizer aligned with the first lower sub-polarizer and a second upper sub-polarizer aligned with the second lower sub-polarizer. The light emitting device is configured to provide an excitation light to the sensing device.

### BACKGROUND

### Field of Invention

The present disclosure relates to the biosensing system and its biodetection method. More particularly, the present disclosure relates to the sensing device and the optical device of the biosensing system for fluorescence biodetection.

### Description of Related Art

A fluorescence biosensing system mainly uses multiple wavelengths to excite the biosamples labelled with various fluorescence tags while there are more than two bio-molecules need to be identified. After the fluorescence tag absorb the corresponding wavelength of the excitation light, the fluorescence biosensing system receives the emitting light emitted by the fluorescence tag and thus identifies the labelled biosample. However, it is difficult to integrate the optical modules with multiple wavelengths on a single sensing area due to the lack of an ideal excitation rejection filter with multiple stop bands for excitations and multiple transmission bands for fluorescence emissions, which leads to the complicated operating steps of the fluorescence biosensing system.

### SUMMARY

The present disclosure provides a fluorescence biosensing system including an integrated sensing device and a light emitting device, thereby simplifying the operation of the biodetection method using the fluorescence biosensing system.

According to some embodiments of the present disclosure, a fluorescence biosensing system including a sensing device and a light emitting device is provided. The sensing device includes a sensing region, a lower polarizer above the sensing region, a light transmitting element above the lower polarizer, and an upper polarizer above the light transmitting element. The lower polarizer includes a first lower sub-polarizer and a second lower sub-polarizer, and a second polarization direction of the second lower sub-polarizer is 90 degrees shifted from a first polarization direction of the first lower sub-polarizer. The upper polarizer includes a first upper sub-polarizer aligned with the first lower sub-polarizer and a second upper sub-polarizer aligned with the second lower sub-polarizer. The light emitting device is configured to provide an excitation light to the sensing device.

In some embodiments, the first upper sub-polarizer has the first polarization direction, and the second upper sub-polarizer has the second polarization direction.

In some embodiments, the first upper sub-polarizer and the second upper sub-polarizer have the first polarization direction.

In some embodiments, the first lower sub-polarizer and the second lower sub-polarizer have different grating periods.

In some embodiments, the sensing region includes a photodiode overlapped by the first lower sub-polarizer and the second lower sub-polarizer.

In some embodiments, the sensing region includes a first photodiode overlapped by the first lower sub-polarizer and a second photodiode overlapped by the second lower sub-polarizer.

In some embodiments, the sensing device further includes a well extended from the upper polarizer into the light transmitting element, and a bottom surface of the well is a reaction area of the sensing device.

In some embodiments, a portion of the light transmitting element is between the bottom surface of the well and the lower polarizer.

In some embodiments, the light transmitting element is a micro lens or a prism configured to refract the excitation light toward the bottom surface of the well.

In some embodiments, the upper polarizer is separated from the lower polarizer by the light transmitting element.

In some embodiments, the sensing device further includes a cover above the upper polarizer, and an imaging medium filled between the cover and the upper polarizer.

In some embodiments, a refractive index of the imaging medium is smaller than a refractive index of the light transmitting element.

In some embodiments, a difference between a refractive index of the imaging medium and a refractive index of the light transmitting element is larger than 0.1.

In some embodiments, the upper polarizer physically contacts the light transmitting element.

In some embodiments, the sensing device further includes a planarization layer between the light transmitting element and the upper polarizer, and a refractive index of the planarization layer is smaller than a refractive index of the light transmitting element.

In some embodiments, the sensing device further includes an excitation light rejection filter between the sensing region and the lower polarizer.

In some embodiments, the light emitting device includes a first light emitting unit configured to emit a first light having the first polarization direction, a second light emitting unit configured to emit a second light having the second polarization direction, and a dichroic mirror configured to combine the first light and the second light into the excitation light.

In some embodiments, the first light emitting unit and the second light emitting unit are independently controlled.

In some embodiments, the excitation light provided to the sensing device is non-polarized.

According to some embodiments of the present disclosure, a biodetection method is provided with the following steps. A fluorescence biosensing system including a sensing device and a light emitting device is provided, in which the sensing device includes a first upper sub-polarizer aligned with a first lower sub-polarizer and a second upper sub-polarizer aligned with a second lower sub-polarizer. A sample is disposed at a reaction area of the sensing device. An excitation light is emitted to the first upper sub-polarizer and the second upper sub-polarizer by the light emitting device to obtain a polarized excitation light. The polarized excitation light is refracted toward the reaction area, which a portion of the polarized excitation light passing through the first upper sub-polarizer reaches the second lower sub-polarizer. The portion of the polarized excitation light is reflected out of the sensing device by the second lower sub-polarizer. An emission light from the sample is detected by the sensing device.

According to the above-mentioned embodiments, the fluorescence biosensing system includes a sensing device and a light emitting device. The light transmitting element of the sensing device refracts the excitation light to enhance the excitation light energy for the sample in the sensing device. The lower polarizer and the upper polarizer of the sensing device have two polarization directions, which provides the simplified biodetection method and improves the accuracy of the fluorescence biosensing system.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a schematic view of a fluorescence biosensing system according to some embodiments of the present disclosure.

FIG. 2A illustrates a cross-sectional view of a sensing device according to one embodiment of the present disclosure. FIGS. 2B-2D illustrate cross-sectional views of the sensing device in FIG. 2A along lines B-B′, C-C′ and D-D′, respectively.

FIGS. 3A-3D illustrate cross-sectional views of a sensing device during biodetection method according to one embodiment of the present disclosure.

FIGS. 4A-4B illustrate cross-sectional views of a sensing device during biodetection method according to one embodiment of the present disclosure.

FIGS. 5-7 illustrate spectrums of fluorescence tags used in the fluorescence biosensing system according to some embodiments of the present disclosure.

FIGS. 8-9 illustrate cross-sectional views of a sensing device during biodetection method according to some embodiments of the present disclosure.

FIG. 10A illustrates a cross-sectional view of a sensing device according to one embodiment of the present disclosure. FIGS. 10B-10D illustrate cross-sectional views of the sensing device in FIG. 10A along lines B-B′, C-C′ and D-D′, respectively.

FIG. 11A illustrates a cross-sectional view of a sensing device according to one embodiment of the present disclosure. FIGS. 11B-11D illustrate cross-sectional views of the sensing device in FIG. 11A along lines B-B′, C-C′ and D-D′, respectively.

FIGS. 12A-12B illustrate cross-sectional views of a sensing device during biodetection method according to one embodiment of the present disclosure.

FIG. 13A illustrates a cross-sectional view of a sensing device according to one embodiment of the present disclosure. FIGS. 13B-13D illustrate cross-sectional views of the sensing device in FIG. 13A along lines B-B′, C-C′ and D-D′, respectively.

FIG. 14 illustrates a cross-sectional view of a sensing device according to one embodiment of the present disclosure.

FIG. 15A illustrates a cross-sectional view of a sensing device according to one embodiment of the present disclosure. FIGS. 15B-15D illustrate cross-sectional views of the sensing device in FIG. 15A along lines B-B′, C-C′ and D-D′, respectively.

FIGS. 16A-16D illustrate cross-sectional views of a sensing device during biodetection method according to one embodiment of the present disclosure.

FIG. 17 illustrates a schematic view of a fluorescence biosensing system according to some embodiments of the present disclosure.

### DETAILED DESCRIPTION

The following disclosure provides many different embodiments, or examples, for implementing different features of the provided subject matter. Specific examples of components, arrangements, etc., are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

It should be understood that although the terms “first”, “second”, “third”, etc., can be used to describe various elements, components, regions, layers and/or parts in this specification, these elements, components, regions, layers and/or parts should not be limited by these terms. These terms are used only to distinguish one element, component, region, layer, or part from another element, component, region, layer, or part. Therefore, the first element, component, region, layer, or part discussed below may be referred to as a second element, component, region, layer, or part without departing from the instructions of the specification.

The present disclosure provides a fluorescence biosensing system including a sensing device and a light emitting device, in which the sensing device integrates a lower polarizer, a light transmitting element, and an upper polarizer together. The light transmitting element refracts the excitation light to enhance the excitation light energy for the sample in the sensing device. The polarization direction of the sub-polarizers of the lower polarizer and the upper polarizer provides the simplified biodetection method and controls the light pathway to improve the accuracy of the fluorescence biosensing system.

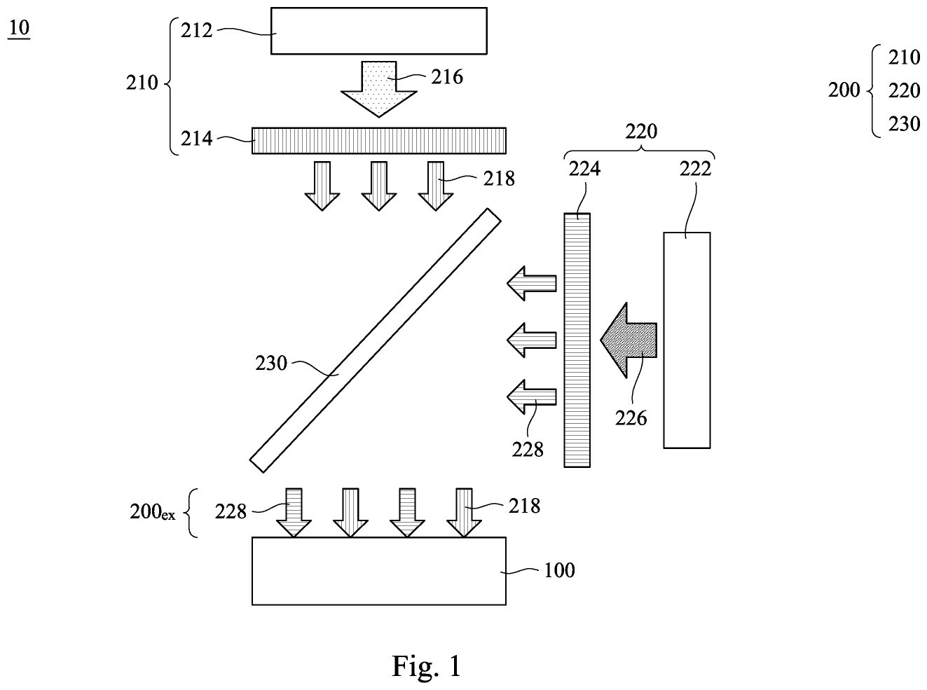

According to some embodiments of the present disclosure, FIG. 1 illustrates a schematic view of a fluorescence biosensing system 10. The fluorescence biosensing system 10 includes a sensing device 100 and a light emitting device 200. During the biodetection method using the fluorescence biosensing system 10, the sample is disposed in the sensing device 100. The light emitting device 200 is configured to provide an excitation light 200ex to the sensing device 100, so that the fluorescence sample may absorb the excitation light 200ex. After the sample absorbs the excitation light 200ex, the sensing device 100 receives the light emitted by the sample to identify the sample.

Specifically, the light emitting device 200 may include a first light emitting unit 210, a second light emitting unit 220, and a dichroic mirror 230. The first light emitting unit 210 is configured to emit a first light 218 having a first polarization direction. Similarly, the second light emitting unit 220 is configured to emit a second light 228 having a second polarization direction. The second polarization direction of the second light 228 is 90 degrees shifted from the first polarization direction of the first light 218. For example, the first light emitting unit 210 may include a first light source 212 emitting a non-polarized light 216 and a first polarizer 214 for filtering the non-polarized light 216 into the polarized first light 218. The second light emitting unit 220 may include a second light source 222 emitting a non-polarized light 226 and a second polarizer 224 for filtering the non-polarized light 226 into the polarized second light 228.

In some embodiments, the wavelength of the first light source 212 may be different from that of the second light source 222. As a result, the first light 218 and the second light 228 have different polarization directions and different wavelengths. For example, the wavelength of the first light source 212 may be about 532 nm so that the first light 218 is a polarized green light. The wavelength of the second light source 222 may be about 633 nm so that the second light 228 is a polarized red light.

The dichroic mirror 230 is configured to combine the first light 218 and the second light 228 into the excitation light 200ex. For example, as shown in FIG. 1, the first light 218 may pass through the dichroic mirror 230 while the second light 228 may be reflected by the dichroic mirror 230. When the first light emitting unit 210 and the second light emitting unit 220 are turned on, the first light 218 with the first polarization direction and the second light 228 with the second polarization direction are mixed to form the excitation light 200ex. In some embodiments, the first light emitting unit 210 and the second light emitting unit 220 may be independently controlled. In such embodiments, the excitation light 200ex may be the first light 218 having a first wavelength, the second light 228 having a second wavelength different from the first wavelength, or a combination thereof.

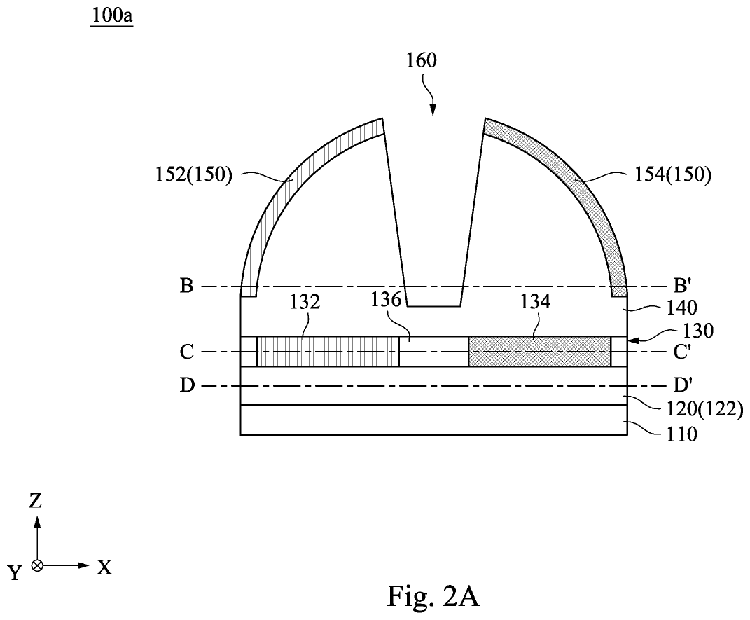

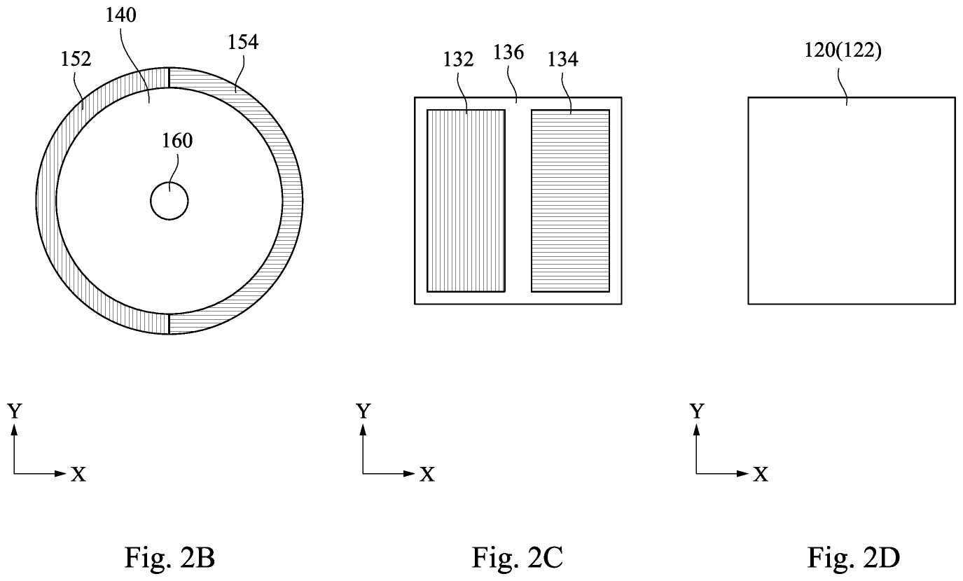

To clearly describe the sensing device 100 in FIG. 1, FIG. 2A illustrates a cross-sectional view of the sensing device 100a that may be used in the fluorescence biosensing system 10. FIGS. 2B-2D illustrate cross-sectional views of the sensing device 100a in FIG. 2A along lines B-B′, C-C′ and D-D′, respectively. The sensing device 100a includes a substrate 110, a sensing region 120 on the substrate 110, a lower polarizer 130 above the sensing region 120, a light transmitting element 140 above the lower polarizer 130, and an upper polarizer 150 above the light transmitting element 140. When the excitation light 200ex (referring to FIG. 1) reaches the sensing device 100a, the excitation light 200ex passes through the upper polarizer 150 and the light transmitting element 140 to be absorbed by the sample in the sensing device 100a. The emitting light from the sample then passes through the lower polarizer 130 and is detected by the sensing region 120.

Specifically, the lower polarizer 130 includes a first lower sub-polarizer 132 and a second lower sub-polarizer 134. The first lower sub-polarizer 132 has the first polarization direction same as the first polarizer 214 in FIG. 1, and the second lower sub-polarizer 134 has the second polarization direction same as the second polarizer 224 in FIG. 1. In other words, the second polarization direction of the second lower sub-polarizer 134 is 90 degrees shifted from the first polarization direction of the first lower sub-polarizer 132.

The upper polarizer 150 includes a first upper sub-polarizer 152 and a second upper sub-polarizer 154. Similarly, the first upper sub-polarizer 152 has the first polarization direction that is 90 degrees shifted from the second polarization direction of the second upper sub-polarizer 154. In other words, the first upper sub-polarizer 152 and the first lower sub-polarizer 132 have the same polarization direction, and so do the second upper sub-polarizer 154 and the second lower sub-polarizer 134. In addition, the first upper sub-polarizer 152 is aligned with the first lower sub-polarizer 132 along the Z-axis, and the second upper sub-polarizer 154 is aligned with the second lower sub-polarizer 134 along the Z-axis. The polarization direction of the aligned lower and upper sub-polarizers may simplify the biodetection method using the sensing device 100a, which will be later discussed in more details.

In some embodiments, the light transmitting element 140 may be sandwiched by the upper polarizer 150 and the lower polarizer 130. As shown in FIG. 2A, the upper polarizer 150 may physically contact the top surface of the light transmitting element 140, and the lower polarizer 130 may physically contact the bottom surface of the light transmitting element 140. In such embodiments, the upper polarizer 150 and the lower polarizer 130 may be conformal to the top surface and the bottom surface of the light transmitting element 140, respectively.

In some embodiments, the sensing device 100a may further include a well 160 extended from the upper polarizer 150 into the light transmitting element 140. As shown in FIG. 2A, the well 160 penetrates through the upper polarizer 150 and into the light transmitting element 140, so that a portion of the light transmitting element 140 is between the bottom surface of the well 160 and the lower polarizer 130. Although the well 160 in FIG. 2A has a lower portion smaller than an upper portion near the upper polarizer 150, the well 160 having other shapes are also contemplated.

During the biodetection method using the device 100a, the bottom surface of the well 160 may act as a reaction area of the sensing device 100a. In other words, the sample may be disposed on the bottom surface of the well 160 to react with other chemicals, such as fluorescence tags, before absorbing the excitation light. In such embodiments, the light transmitting element 140 may be formed of dielectric materials with high transmittance. As the well 160 exposes the light transmitting element 140, the well 160 provides the dielectric bottom surface where may be treated with surface functional groups for disposing the sample. This increases the binding force between the sample and the sensing device 100a, thereby lowering the risk of losing the sample during the biodetection process.

In some embodiments, the first lower sub-polarizer 132 and the second lower sub-polarizer 134 may be connected by a metal layer 136. The metal layer 136 may reduce the possibility of the excitation light reaching the sensing region 120, which improves the accuracy of the sensing device 100a. The metal layer 136 may be formed of the same material as the lower polarizer 130, such as Al, Ag, Au, Cu, W, or combinations thereof.

In some embodiments which the well 160 extends into the light transmitting element 140, the metal layer 136 may be aligned with the bottom surface of the well 160 along the Z-axis, so that it is difficult for the excitation light entering the well 160 to reach the sensing region 120. For example, as shown in FIG. 2A, the sensing region 120 may include a photodiode 122 overlapped by the first lower sub-polarizer 132, the second lower sub-polarizer 134, and the metal layer 136. The width of the metal layer 136 along the X-axis may be close to the width of the bottom surface of the well 160. As a result, when the excitation light enters the well 160 along the Z-axis, the metal layer 136 may reduce the possibility of the excitation light reaching the sensing region 120.

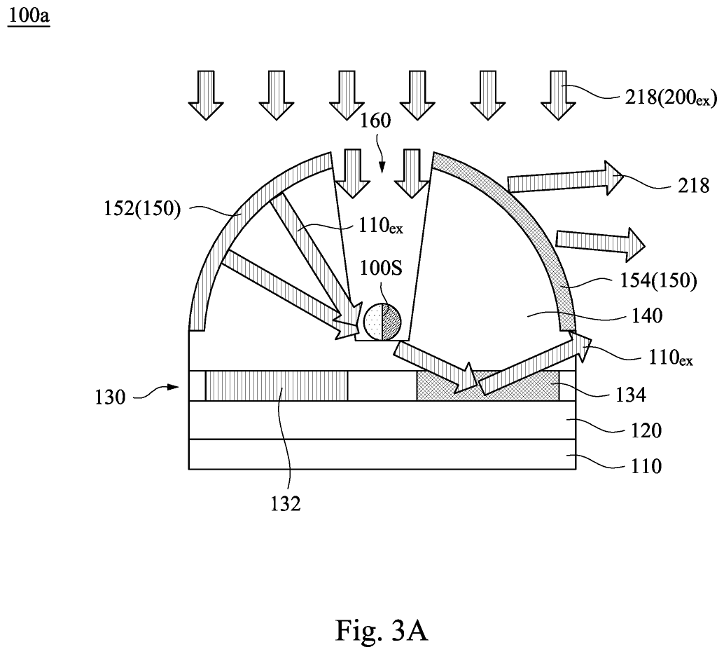

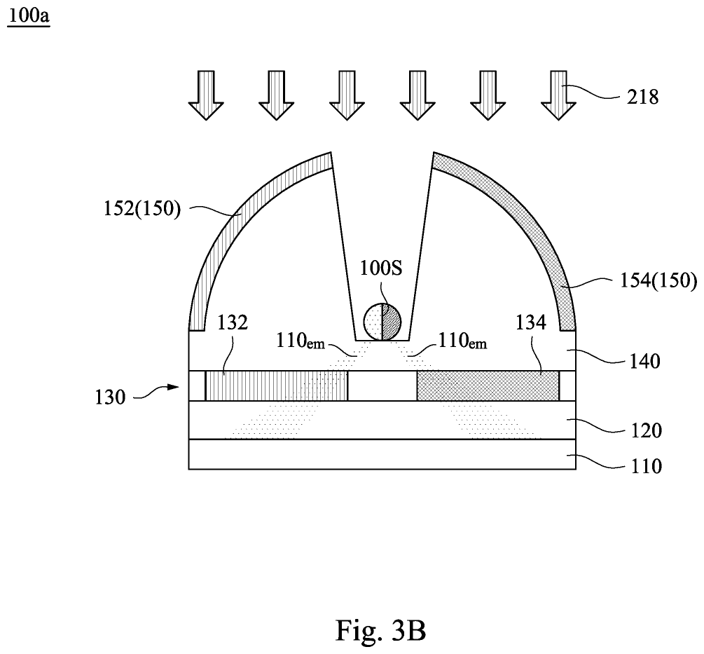

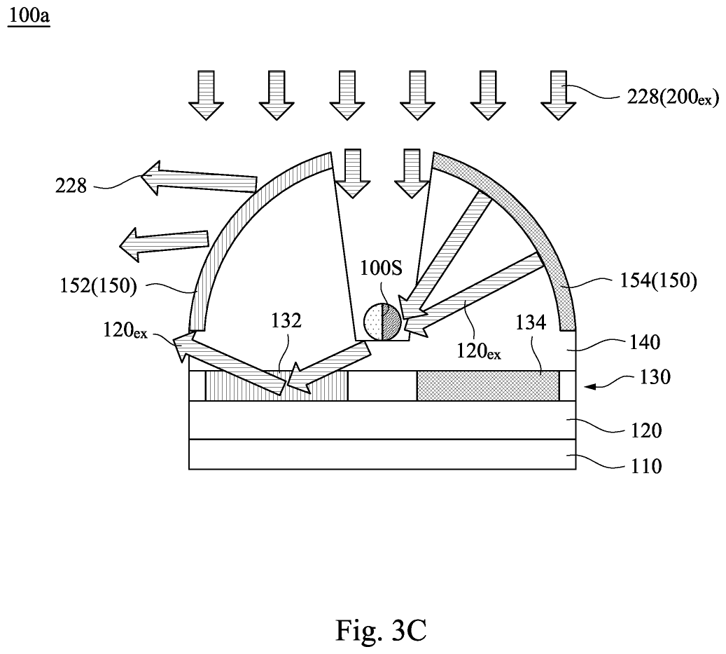

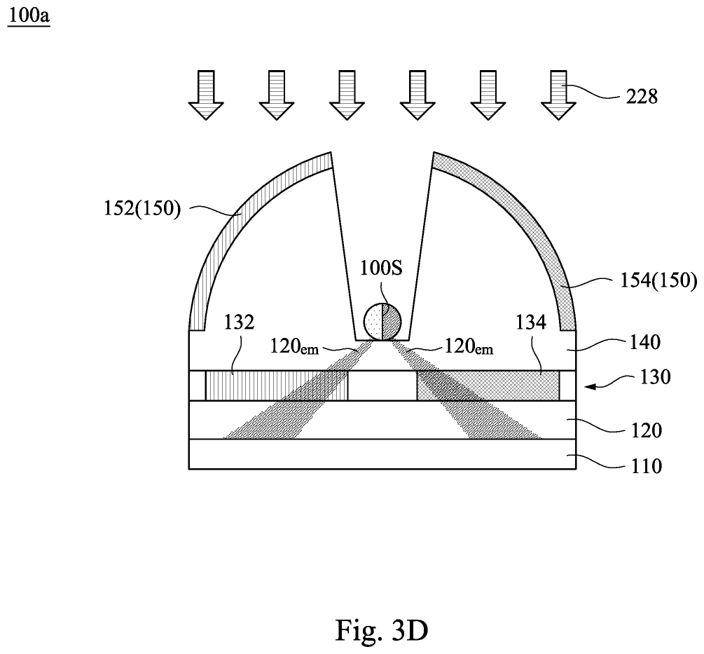

According to one embodiment of the present disclosure, FIGS. 3A-3D illustrate cross-sectional views of the sensing device 100a during the biodetection method. The sensing device 100a in FIGS. 3A-3D is used as the sensing device 100 of the fluorescence biosensing system 10 in FIG. 1. Specifically, a sample 100S is first disposed at the reaction area (i.e., the bottom surface of the well 160) of the sensing device 100a. The sample 100S is illustrated with two types of screentones to indicate that the sample 100S has two types of fluorescence tags respectively absorbing the first light 218 and the second light 228. The sample 100S may be labelled with the fluorescence tags before being disposed in the sensing device 100a, or be labelled with the fluorescence tags by a bioreaction after being disposed at the reaction area.

Referring to FIG. 3A, the first light 218 (or referred as the excitation light 200ex) is emitted to the sensing device 100a. When the first light 218 reaches the first upper sub-polarizer 152 of the upper polarizer 150, the first light 218 passes through the first upper sub-polarizer 152 due to the common first polarization direction. The portion of the first light 218 passing through the first upper sub-polarizer 152 may be referred as the polarized excitation light 110ex having the first polarization direction. On the other hand, the second polarization direction of the second upper sub-polarizer 154 is 90 degrees shifted from the first polarization direction of the first light 218. As a result, the first light 218 reaching the second upper sub-polarizer 154 is reflected by the second upper sub-polarizer 154.

The polarized excitation light 110ex is then refracted toward the reaction area of the sensing device 100a to focus the excitation energy for the sample 100S. However, the sample 100S may not completely absorb the polarized excitation light 110ex. As shown in FIG. 3A, a portion of the polarized excitation light 110ex may pass through the reaction area and reach the lower polarizer 130. Since the polarized excitation light 110ex is refracted from the first upper sub-polarizer 152 toward the reaction area, the portion of the polarized excitation light 110ex reaches the second lower sub-polarizer 134 on the diagonal light path.

The second polarization direction of the second lower sub-polarizer 134 is 90 degrees shifted from the first polarization direction of the polarized excitation light 110ex, so that the portion of the polarized excitation light 110ex reaching the second lower sub-polarizer 134 is reflected by the second lower sub-polarizer 134. As shown in FIG. 3A, the upper polarizer 150 is separated from the lower polarizer 130 by the light transmitting element 140, which leaves a channel for the polarized excitation light 110ex to leave the light transmitting element 140. As a result, the portion of the polarized excitation light 110ex is reflected out of the sensing device 100a by the second lower sub-polarizer 134. In other words, the second lower sub-polarizer 134 reduces the possibility of the polarized excitation light 110ex reaching the sensing region 120.

Referring to FIG. 3B, the sample 100S emits the emission light 110em after absorbing the polarized excitation light 110ex. The emission light 110em is non-polarized, so that the emission light 110em may pass through both the first lower sub-polarizer 132 and the second lower sub-polarizer 134. The emission light 110em is then detected by the sensing region 120, which allows the sensing device 100a to identify the fluorescence tag on the sample 100S corresponding to the excitation of the first light 218.

Referring to FIG. 3C, the second light 228 (or referred as the excitation light 200ex) is emitted to the sensing device 100a. When the second light 228 reaches the upper polarizer 150, the second light 228 passes through the second upper sub-polarizer 154 and is reflected by the first upper sub-polarizer 152 due to the polarization directions 90 degrees shifted from each other. The portion of the second light 228 passing through the second upper sub-polarizer 154 may be referred as the polarized excitation light 120ex having the second polarization direction. The polarized excitation light 120ex is refracted toward the reaction area of the sensing device 100a.

A portion of the polarized excitation light 120ex may pass through the reaction area, and then be reflected by the first lower sub-polarizer 132 due to the 90 degrees shifted polarization directions. As shown in FIG. 3C, the upper polarizer 150 is separated from the lower polarizer 130 by the light transmitting element 140. The portion of the polarized excitation light 120ex is reflected out of the sensing device 100a by the first lower sub-polarizer 132 and through the light transmitting element 140. In other words, the first lower sub-polarizer 132 reduces the possibility of the polarized excitation light 120ex reaching the sensing region 120.

Referring to FIG. 3D, the sample 100S emits the emission light 120em after absorbing the polarized excitation light 120ex. The emission light 120em passes through both the first lower sub-polarizer 132 and the second lower sub-polarizer 134, and is detected by the sensing region 120 to identify the fluorescence tag on the sample 100S corresponding to the excitation of the second light 228.

Through the biodetection method shown in FIGS. 3A-3D, the fluorescence biosensing system 10 including the sensing device 100a of FIGS. 2A-2D and the light emitting device 200 of FIG. 1 may identify the two types of fluorescence tags by a two-step excitation. More specifically, the light emitting device 200 is able to provide the first light 218 and the second light 228 with different wavelengths. When one of the two fluorescence tags is excited by the first light 218, the sensing device 100a detects the emission light 110em with a first wavelength. When the other one of the two fluorescence tags is excited by the second light 228, the sensing device 100a detects the emission light 120em with a second wavelength. Therefore, the fluorescence biosensing system 10 may identify the two types of fluorescence tags by measuring the intensities of the first wavelength and the second wavelength.

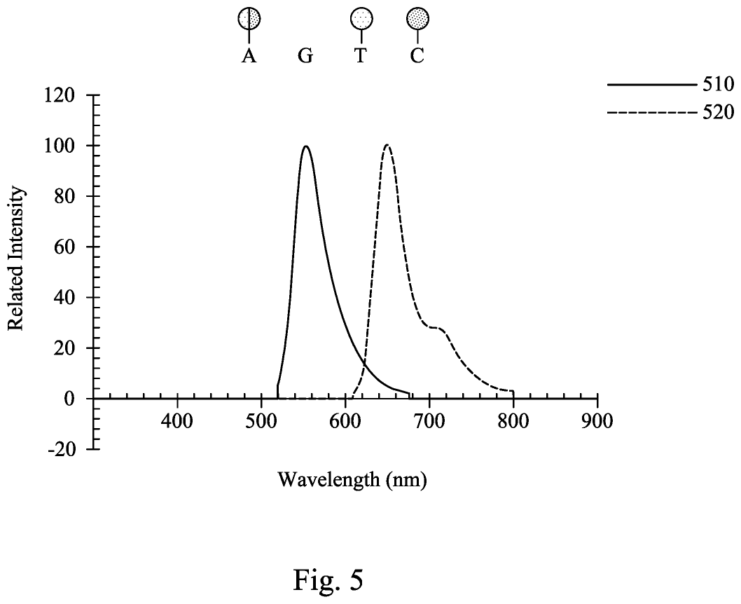

FIG. 5 illustrates an emission spectrum of two types of fluorescence tags used in the fluorescence biosensing system as an exemplary embodiment of the biodetection method in FIGS. 3A-3D. In the embodiment illustrated in FIG. 5, the four types of samples are DNA units A, G, T, and C. DNA unit T is labelled with a fluorescence tag 510 corresponding to the green emission light, such as Alexa 532. DNA unit C is labelled with a fluorescence tag 520 corresponding to the red emission light, such as Alexa633. DNA unit A is labelled with two fluorescence tags 510 and 520. DNA unit G is not labelled with anyone of the two fluorescence tags 510 and 520. It should be noted that the responsivity of the sensing device to the fluorescence tag 510 is equal to that of the fluorescence tag 520.

When the biodetection method in FIGS. 3A-3D is performed with the samples in FIG. 5, the green emission light of the fluorescence tag 510 acts as the emission light 110em, and the red emission light of the fluorescence tag 520 acts as the emission light 120em. The result obtained by the fluorescence biosensing system is shown in the following Table 1. As shown in Table 1, the four types of samples show different intensities of the green and red emission lights after two-step excitation. Therefore, the fluorescence biosensing system is able to distinguish the four samples from each other.

TABLE 1

| | Sample | A | G | T | C |
|---|---|---|---|---|---|
| 1^{st} excitation | Intensity of green emission light | 1X | 0 | 1X | 0 |
| 2^{nd} excitation | Intensity of red emission light | 1X | 0 | 0 | 1X |

The fluorescence biosensing system 10 including the sensing device 100a and the light emitting device 200 may perform the two-step excitation of the biodetection method shown in FIGS. 3A-3D. The two-step excitation includes a first excitation step (referring to FIG. 3A), a first sensing step (referring to FIG. 3B) after the first excitation step, a second excitation step (referring to FIG. 3C), and a second sensing step (referring to FIG. 3D) after the second excitation step. In some other embodiments, the fluorescence biosensing system 10 may identify the two types of fluorescence tags by one-step excitation. In the one-step excitation method, two wavelengths of the excitation light are simultaneously provided in one excitation step, and two wavelengths of the emission light are simultaneously measured in one sensing step.

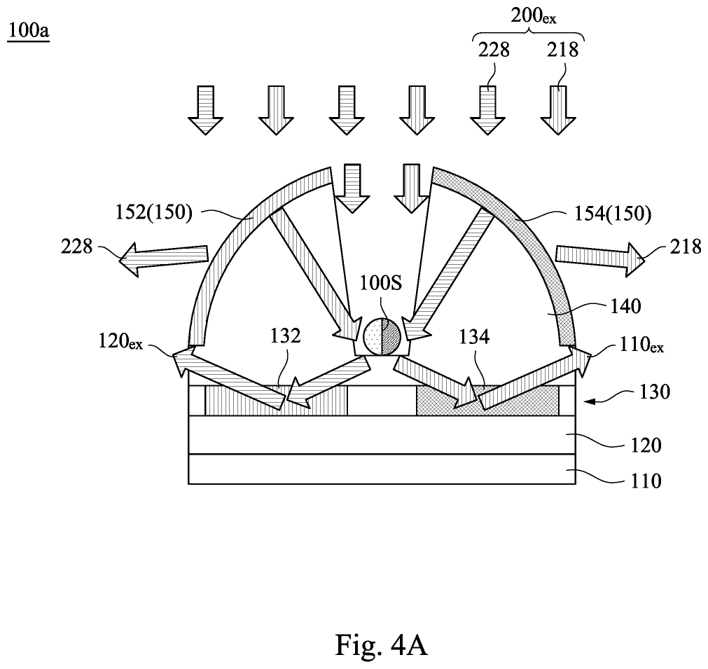

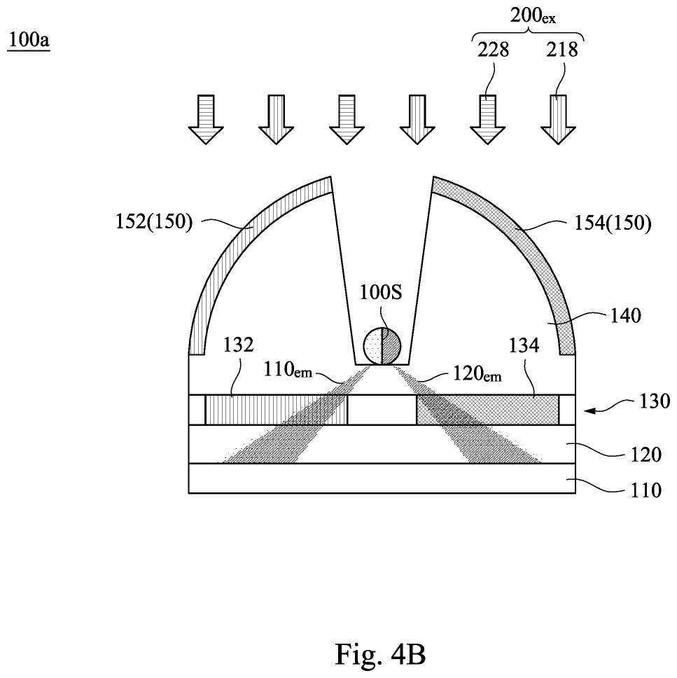

According to one embodiment of the present disclosure, FIGS. 4A-4B illustrate cross-sectional views of the sensing device 100a during the biodetection method. The operation details of the biodetection method of FIGS. 4A-4B are similar to those of the biodetection method of FIGS. 3A-3D. The difference between them is the amount of the operating steps. Referring to FIG. 4A, the first light 218 and the second light 228 are simultaneously provided as the excitation light 200ex. In other words, the excitation steps shown in FIGS. 3A and 3C are combined into one excitation step shown in FIG. 4A. Similarly, the emission light 110em and the emission light 120em are simultaneously measured by the sensing region 120. The sensing steps shown in FIGS. 3B and 3D are combined into one sensing step shown in FIG. 4B.

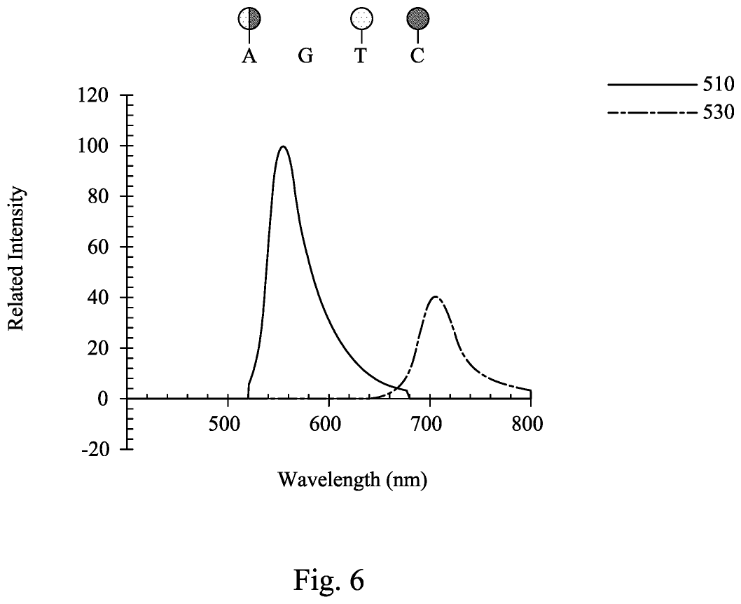

FIG. 6 illustrates an emission spectrum of two types of fluorescence tags used in the fluorescence biosensing system as an exemplary embodiment of the biodetection method in FIGS. 4A-4B. In the embodiment illustrated in FIG. 6, the four types of samples are DNA units A, G, T, and C. DNA unit T is labelled with a fluorescence tag 510 corresponding to the green emission light, such as Alexa532. DNA unit C is labelled with a fluorescence tag 530 corresponding to the red emission light, such as Alexa680. DNA unit A is labelled with two fluorescence tags 510 and 530. DNA unit G is not labelled with anyone of the two fluorescence tags 510 and 530. It should be noted that the responsivity of the sensing device to the fluorescence tag 510 is twice higher than that of the fluorescence tag 530.

When the biodetection method in FIGS. 4A-4B is performed with the samples in FIG. 6, the green emission light of the fluorescence tag 510 acts as the emission light 110em, and the red emission light of the fluorescence tag 530 acts as the emission light 120em. The result obtained by the fluorescence biosensing system is shown in the following Table 2. As shown in Table 2, the four types of samples show different total intensities of the emission light after one-step excitation. Therefore, the fluorescence biosensing system is able to distinguish the four samples from each other.

TABLE 2

| | Sample | A | G | T | C |
|---|---|---|---|---|---|
| 1^{st} excitation | Intensity of green emission light | 2X | 0 | 2X | 0 |
| | Intensity of red emission light | 1X | 0 | 0 | 1X |
| | Total intensity of emission light | 3X | 0 | 2X | 1X |

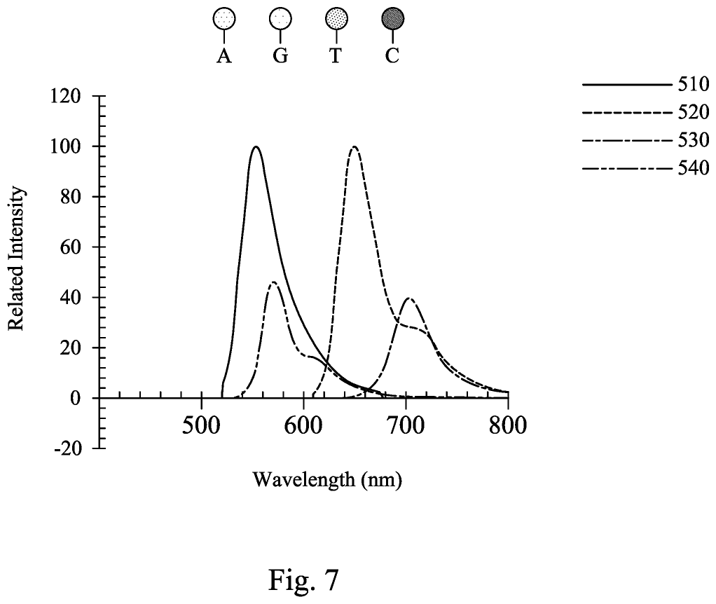

In the embodiments illustrated in FIGS. 5-6, two types of fluorescence tags are used in the fluorescence biosensing system. In some other embodiments, more than two types of fluorescence tags may be used in the fluorescence biosensing system. For example, FIG. 7 illustrates an emission spectrum of four types of fluorescence tags used in the fluorescence biosensing system. The four types of samples are DNA units A, G, T, and C. DNA unit A is labelled with a fluorescence tag 510 corresponding to the green emission light, such as Alexa532. DNA unit T is labelled with a fluorescence tag 520 corresponding to the red emission light, such as Alexa633. DNA unit C is labelled with a fluorescence tag 530 corresponding to the red emission light, such as Alexa680. DNA unit G is labelled with a fluorescence tag 540 corresponding to the green emission light, such as Alexa561. It should be noted that the responsivity of the sensing device to the fluorescence tags 510 and 520 is twice higher than that of the fluorescence tags 530 and 540.

When the biodetection method in FIGS. 3A-3D is performed with the samples in FIG. 7, the green emission light of the fluorescence tags 510 and 530 acts as the emission light 110em, and the red emission light of the fluorescence tags 520 and 540 acts as the emission light 120em. The result obtained by the fluorescence biosensing system is shown in the following Table 3. As shown in Table 3, the four types of samples show different intensities of the green and red emission lights after two-step excitation. Therefore, the fluorescence biosensing system is able to distinguish the four samples from each other.

TABLE 3

| | Sample | A | G | T | C |
|---|---|---|---|---|---|
| 1^{st} excitation | Intensity of green emission light | 2X | 1X | 0 | 0 |
| 2^{nd} excitation | Intensity of red emission light | 0 | 0 | 2X | 1X |

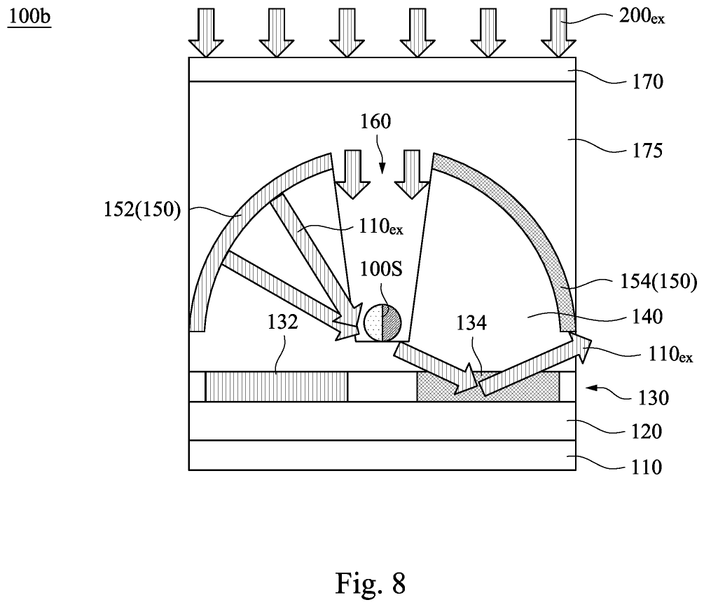

In some embodiments, the sensing device may further include an imaging medium to improve the refraction of the excitation light toward the sample in the sensing device. FIG. 8 illustrates a cross-sectional view of a sensing device 100b during the biodetection method according to one embodiment of the present disclosure. The sensing device 100b is similar to the sensing device 100a in FIG. 2A, except for a cover 170 above the upper polarizer 150, and an imaging medium 175 filled between the cover 170 and the upper polarizer 150.

Specifically, a refractive index of the imaging medium 175 is smaller than a refractive index of the light transmitting element 140. When the excitation light 200ex enters the sensing device 100b, there is nearly no refraction between the imaging medium 175 and the upper polarizer 150. As the excitation light 200ex passing into the light transmitting element 140, the refractive index difference between the imaging medium 175 and the light transmitting element 140 makes it more easily to refract the polarized excitation light 110ex toward the reaction area. In other words, the refractive index difference may increase the light intensity received by the sample at the reaction area.

In some embodiments, the refractive index difference between the imaging medium 175 and the light transmitting element 140 may be larger than 0.1 to significantly increase the light intensity refracted toward the reaction area. For example, when the refractive index of the light transmitting element 140 is about 1.75, the refractive index of the imaging medium 175 may be smaller than 1.65. In such embodiments, the light transmitting element 140 may be formed of SiO₂, TiO₂, Ta₂O₅, SiN, Nb₂O₅, HfO₂, or combinations thereof, and the imaging medium 175 may be air, oil, water, other fluid, or combinations thereof.

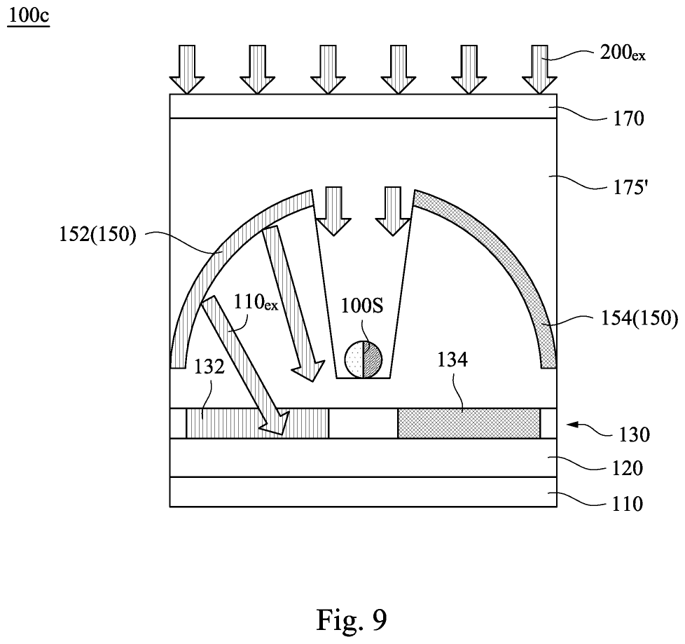

In some embodiments, the refractive index difference between the imaging medium 175 and the light transmitting element 140 may be controlled in a suitable range to focus the refracted excitation light at the reaction area. The refractive index difference may be controlled in a range of 0.1 to 1.35 depends on the geometric optics design among the size and the material of the light transmitting element and the location of the reaction area. For example, in one embodiment, the designed refractive index difference may be 0.35±0.05 while the refractive index of the imaging medium 175 is water with a refractive index about 1.33 and the light transmitting element 140 is Al₂O₃ with a refractive index about 1.68. If the refractive index difference of this embodiment is smaller than 0.3 or larger than 0.4, the pathway of the polarized excitation light 110ex may not pass through the reaction area, leading to a failed sensing device 100c as shown in a cross-sectional view in FIG. 9. The failed sensing device 100c includes a solution 175′ unsuitable for focusing the polarized excitation light 110ex to the reaction area. In such cases, the biodetection method may further include a replacing step to replace the solution 175′, such as a bioreaction solution, with an imaging medium having the suitable refractive index.

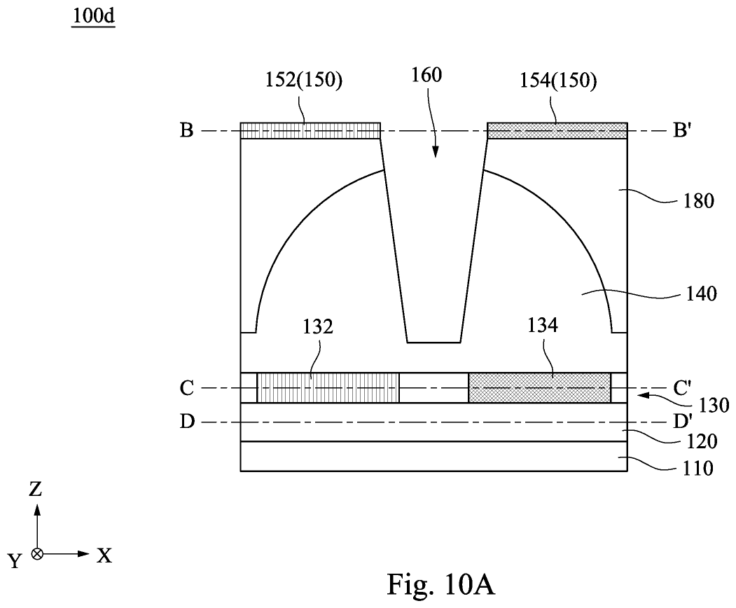

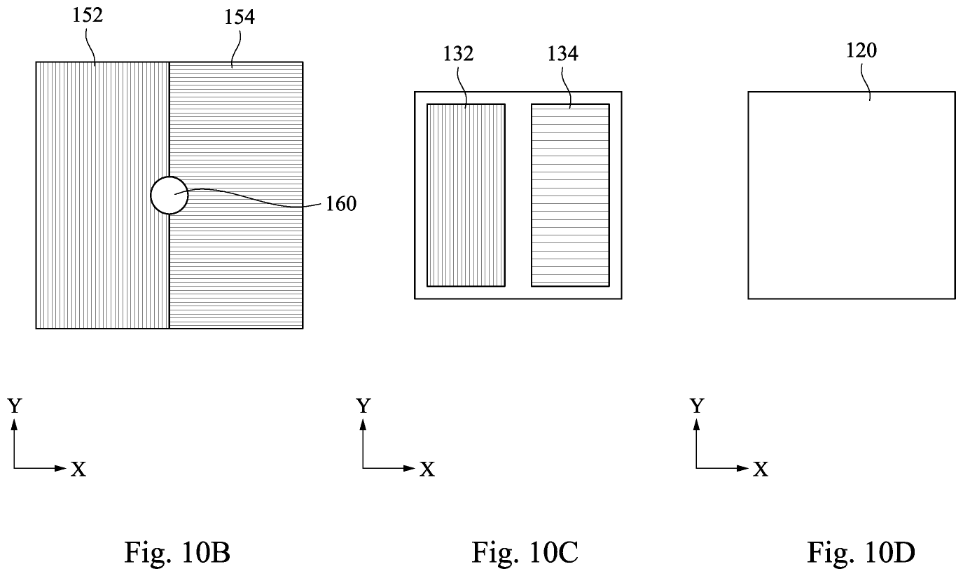

In some embodiments, the sensing device may further include a planarization layer to improve the refraction of the excitation light toward the sample in the sensing device. FIG. 10A illustrates a cross-sectional view of a sensing device 100d according to one embodiment of the present disclosure. FIGS. 10B-10D illustrate cross-sectional views of the sensing device 100d in FIG. 10A along lines B-B′, C-C′ and D-D′, respectively. The sensing device 100d is similar to the sensing device 100a in FIG. 2A, except for a planarization layer 180 between the light transmitting element 140 and the upper polarizer 150. The planarization layer 180 may physically contact the top surface of the light transmitting element 140 and have a planarized top surface. The upper polarizer 150 is disposed on the planarized top surface of the planarization layer 180. The well 160 extends through the upper polarizer 150, the planarization layer 180, and into the light transmitting element 140.

Specifically, a refractive index of the planarization layer 180 is smaller than a refractive index of the light transmitting element 140. When the excitation light enters the sensing device 100d, there is nearly no refraction between the upper polarizer 150 and the planarization layer 180. As the excitation light passing into the light transmitting element 140, the refractive index difference between the planarization layer 180 and the light transmitting element 140 makes it more easily to refract the excitation light. Since the refraction of the excitation light mainly depends on the refractive index difference between the planarization layer 180 and the light transmitting element 140, the influence of the solution in the well 160 to the excitation light refraction is reduced. Therefore, various bioreaction solutions or imaging mediums may be used in the sensing device 100d.

In some embodiments, the refractive index difference between the planarization layer 180 and the light transmitting element 140 may be larger than 0.1 to significantly increase the light intensity refracted toward the reaction area. For example, when the refractive index of the light transmitting element 140 is about 1.75, the refractive index of the planarization layer 180 may be smaller than 1.65. In such embodiments, the light transmitting element 140 may be formed of TiO₂, Ta₂O₅, SiN, Nb₂O₅, HfO₂, or combinations thereof, and the planarization layer 180 may be formed of SiO₂, plastic, photoresist material, resin polymer, or combinations thereof.

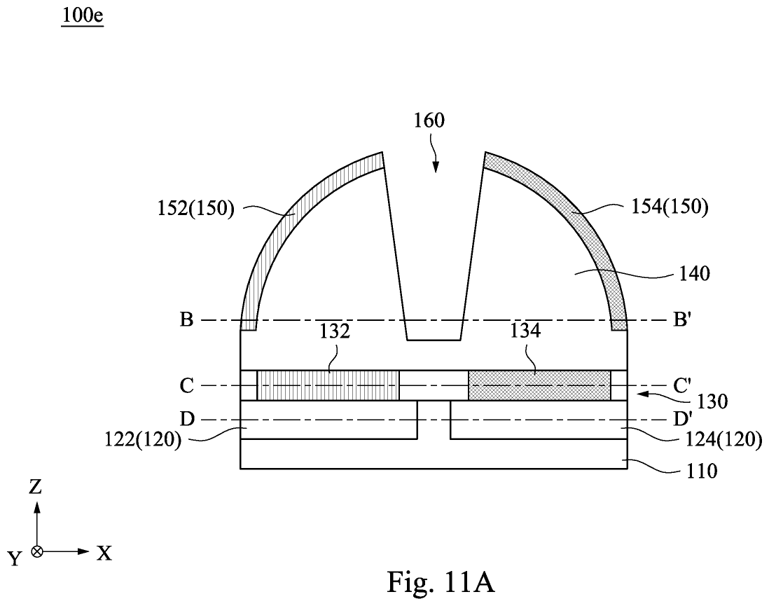

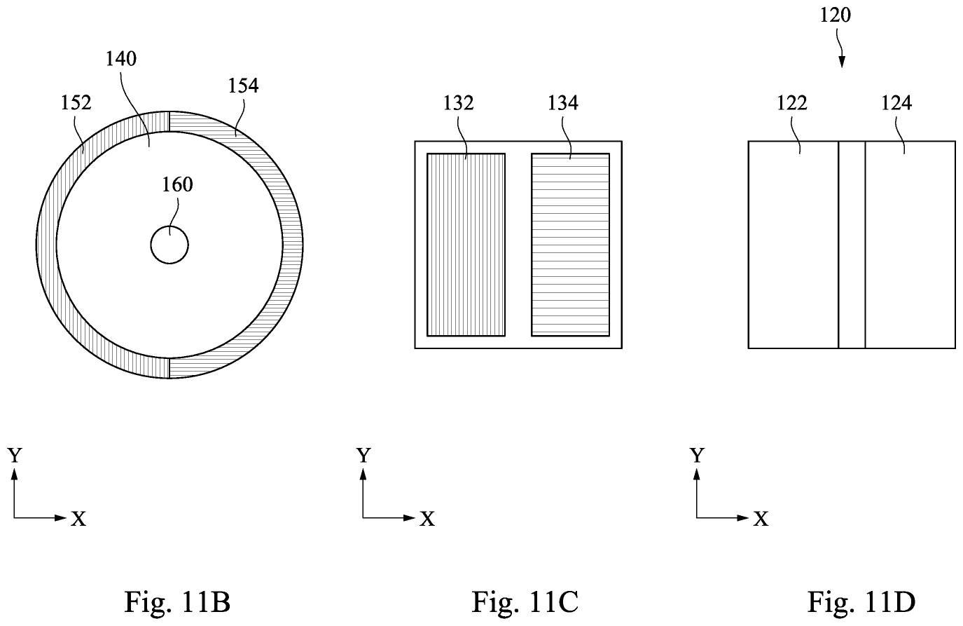

In some embodiments, the first lower sub-polarizer and the second lower sub-polarizer may have different grating periods. The grating period affect the wavelength range passing through the lower polarizer. As a result, the lower polarizer with different grating periods may act as a wavelength filter. FIG. 11A illustrates a cross-sectional view of a sensing device 100e according to one embodiment of the present disclosure. FIGS. 11B-11D illustrate cross-sectional views of the sensing device 100e in FIG. 11A along lines B-B′, C-C′ and D-D′, respectively. The sensing device 100e is similar to the sensing device 100a in FIG. 1, except for the grating periods of the lower polarizer 130 and the arrangement of the sensing region 120.

As shown in FIG. 11C, the second lower sub-polarizer 134 has a grating period larger than that of the first lower sub-polarizer 132. Corresponding to the different grating periods of the lower polarizer 130, the sensing region 120 includes a first photodiode 122 overlapped by the first lower sub-polarizer 132 and a second photodiode 124 overlapped by the second lower sub-polarizer 134. As the sample in the sensing device 100e emits the emission light, the first photodiode 122 detects the emission light passing through the first lower sub-polarizer 132, and the second photodiode 124 detects the emission light passing through the second lower sub-polarizer 134.

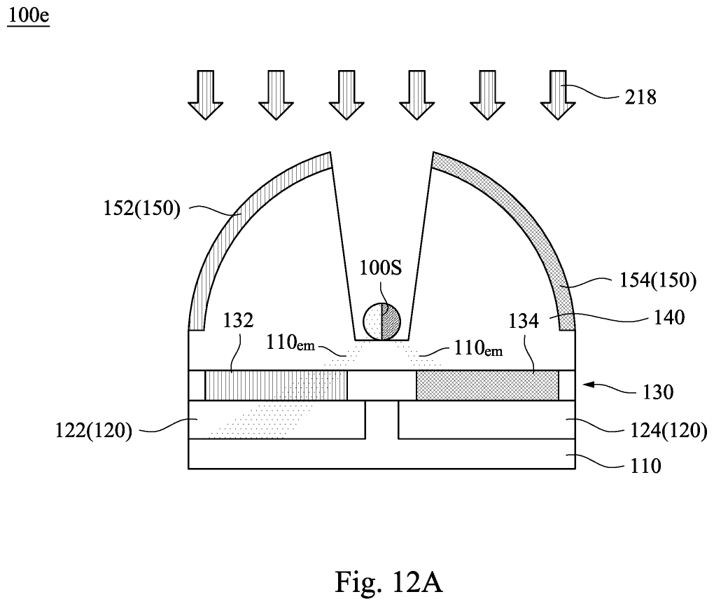

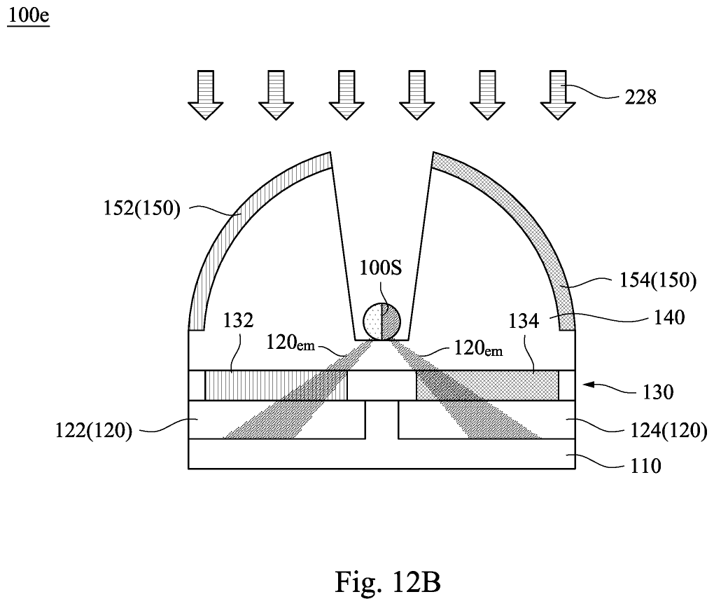

FIGS. 12A-12B illustrate cross-sectional views of the sensing device 100e during the biodetection method similar to that of FIGS. 3A-3D. When the first light 218 having a short wavelength is emitted to the sensing device 100e, the sample 100S emits the emission light 110em with short wavelength. The emission light 110em passes through the first lower sub-polarizer 132 with small grating period and is rejected by the second lower sub-polarizer 134 with large grating period. When the second light 228 having a long wavelength is emitted to the sensing device 100e, the sample 100S emits the emission light 120em with long wavelength. The emission light 120em passes through both the first lower sub-polarizer 132 and the second lower sub-polarizer 134. In such embodiments, the lower polarizer 130 may be referred as a bandpass filter or a longpass filter.

When the biodetection method in FIGS. 12A-12B is performed with the samples in FIG. 5, the green emission light of the fluorescence tag 510 acts as the emission light 110em, and the red emission light of the fluorescence tag 520 acts as the emission light 120em. The result obtained by the fluorescence biosensing system is shown in the following Table 4 and Table 5. As shown in Table 4, the four types of samples show different intensities of the green and red emission lights after two-step excitation. As shown in Table 5, the four types of samples show different total intensities of the emission lights after one-step excitation. Therefore, the fluorescence biosensing system is able to distinguish the four samples from each other.

TABLE 4

| | Sample | A | G | T | C |
|---|---|---|---|---|---|
| 1^{st} excitation | Intensity of green emission light | 1X | 0 | 1X | 0 |
| | detected by first photodiode 122 | | | | |
| | Intensity of green emission light | 0 | 0 | 0 | 0 |
| | detected by second photodiode 124 | | | | |
| 2^{nd} excitation | Intensity of red emission light | 1X | 0 | 0 | 1X |
| | detected by first photodiode 122 | | | | |
| | Intensity of red emission light | 1X | 0 | 0 | 1X |
| | detected by second photodiode 124 | | | | |

TABLE 5

| | Sample | A | G | T | C |
|---|---|---|---|---|---|
| 1^{st} excitation | Total Intensity of emission light | 2X | 0 | 1X | 1X |
| | detected by first photodiode 122 | | | | |
| | Total Intensity of emission light | 1X | 0 | 0 | 1X |
| | detected by second photodiode 124 | | | | |

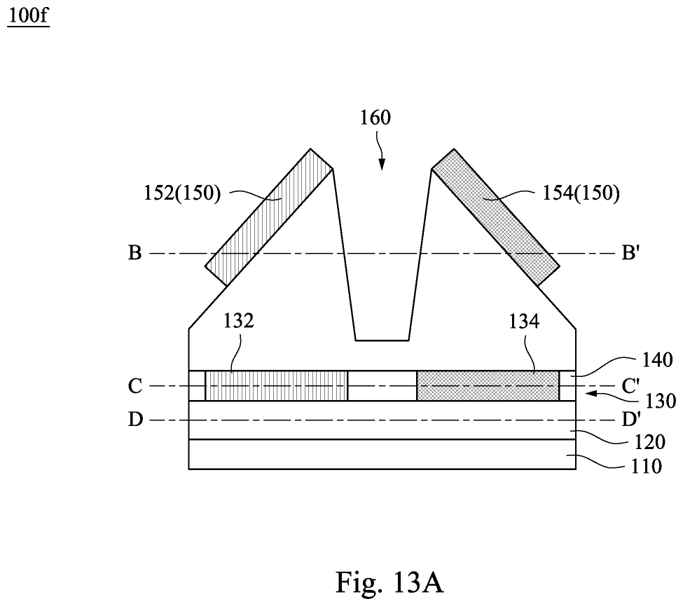

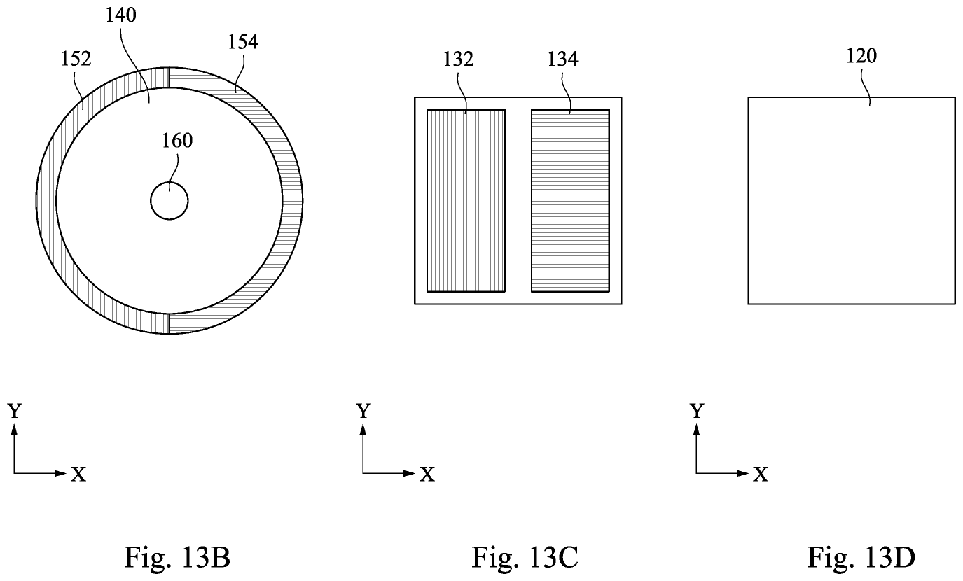

In some embodiments, as shown in FIG. 2A, the light transmitting element 140 may be a micro lens refracting the excitation light toward the bottom surface of the well 160. The curvature of the micro lens may be adjusted to focus the excitation light at the reaction area. In some other embodiments, the light transmitting element 140 may be other shapes that refract the excitation light toward the bottom surface of the well 160. For example, FIG. 13A illustrates a cross-sectional view of a sensing device 100f according to one embodiment of the present disclosure. FIGS. 13B-13D illustrate cross-sectional views of the sensing device 100f in FIG. 13A along lines B-B′, C-C′ and D-D′, respectively. The light transmitting element 140 in FIGS. 13A-13D is a prism that refracts the excitation light toward the bottom surface of the well 160.

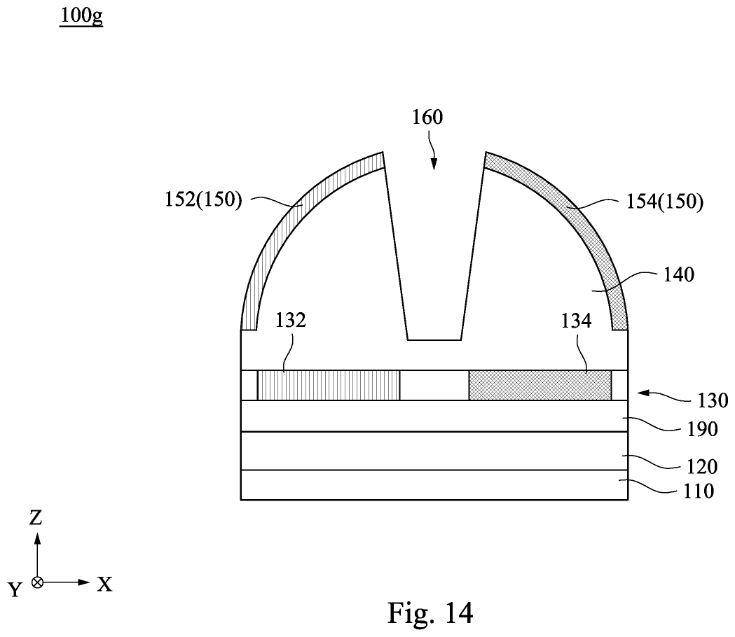

In some embodiments, the sensing device may further include an excitation light rejection filter to reduce the possibility of the excitation light reaching the sensing region. FIG. 14 illustrates a cross-sectional view of a sensing device 100g according to one embodiment of the present disclosure. The sensing device 100g is similar to the sensing device 100a in FIG. 2A, except for the excitation light rejection filter 190 between the sensing region 120 and the lower polarizer 130. For example, the excitation light rejection filter 190 may be a multilayer film that absorbs or reflects the excitation light. The excitation light rejection filter 190 reduces the possibility of the excitation light reaching the sensing region 120, which improves the accuracy of the sensing device 100g.

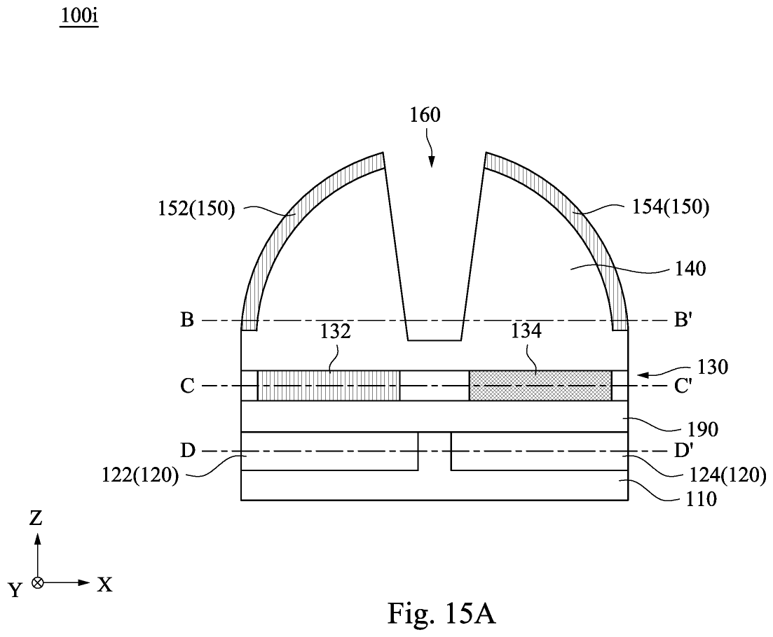

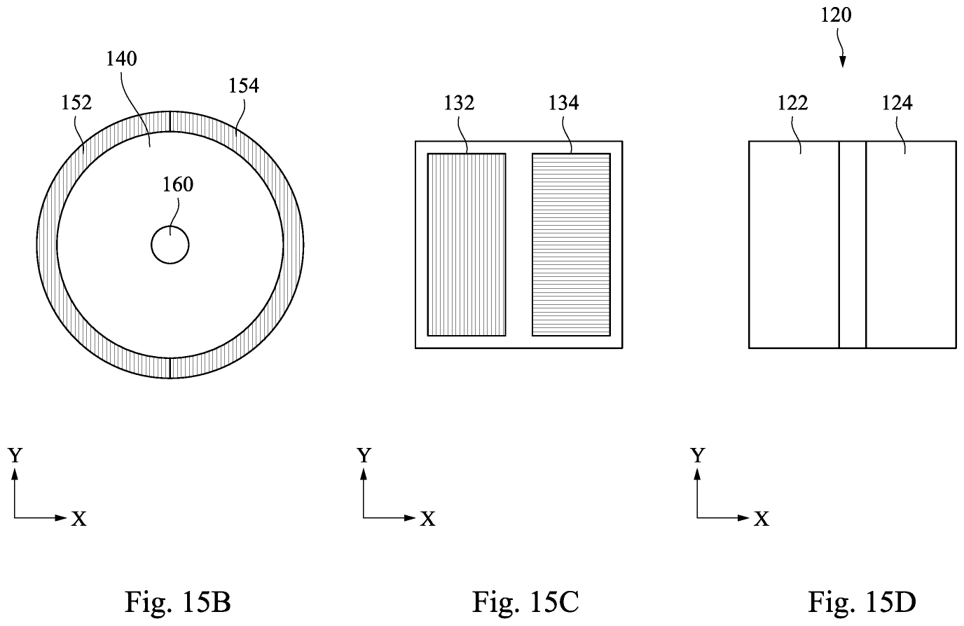

In some embodiments, the upper sub-polarizer may have the same polarization direction as the corresponding lower sub-polarizer. For example, the second upper sub-polarizer 154 in FIGS. 2A-2D has the same polarization direction as the second lower sub-polarizer 134. In some other embodiments, the upper sub-polarizer may have the 90 degrees shifted polarization direction compared to the corresponding lower sub-polarizer. FIG. 15A illustrates a cross-sectional view of a sensing device 100i according to one embodiment of the present disclosure. FIGS. 15B-15D illustrate cross-sectional views of the sensing device 100i in FIG. 15A along lines B-B′, C-C′ and D-D′, respectively. The sensing device 100i is similar to the sensing device 100e in FIG. 11A, except for the polarization direction of the second upper sub-polarizer 154 and the excitation light rejection filter 190.

As shown in FIGS. 15A-15D, the first upper sub-polarizer 152 and the second upper sub-polarizer 154 have the first polarization direction. The first lower sub-polarizer 132 has the first polarization direction, and the second lower sub-polarizer 134 has the second polarization direction. In other words, the first upper sub-polarizer 152 has the same polarization direction as the first lower sub-polarizer 132, while the second upper sub-polarizer 154 has the polarization direction 90 degrees shifted from that of the second lower sub-polarizer 134.

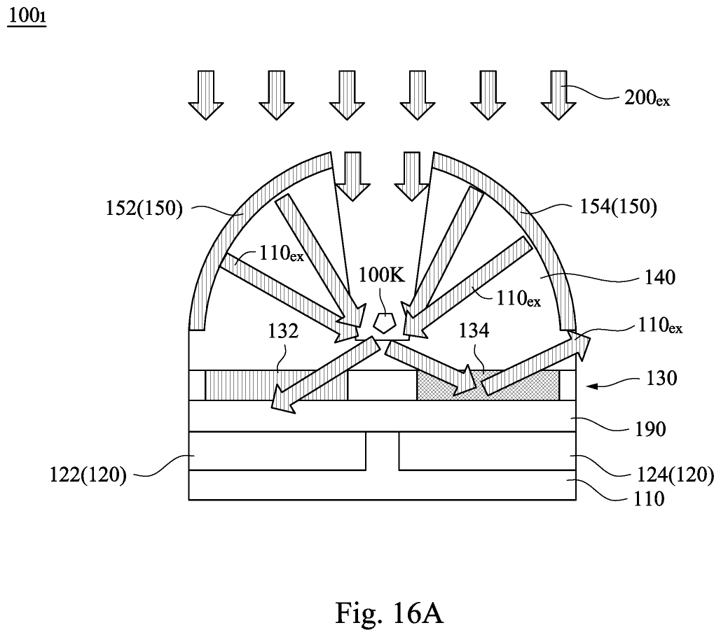

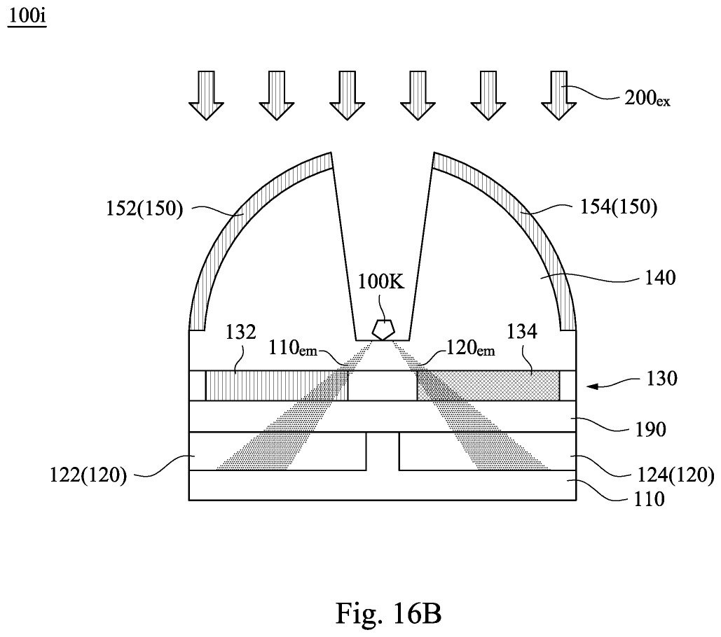

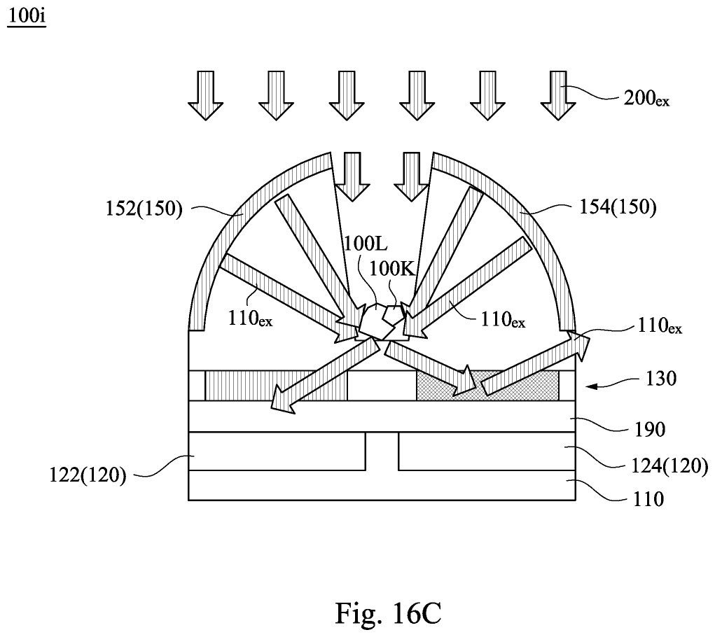

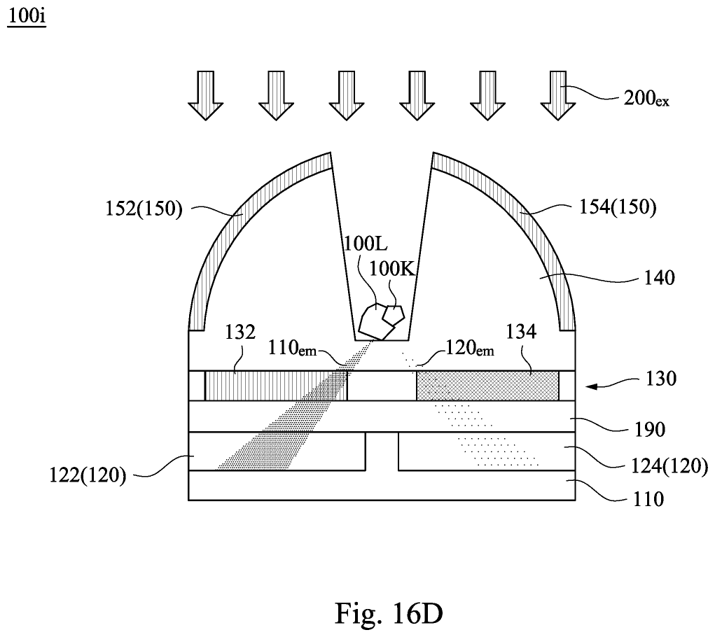

According to one embodiment of the present disclosure, FIGS. 16A-16D illustrate cross-sectional views of the sensing device 100i during a biodetection method called “kinetic fluorescence polarization assay”. The sensing device 100i in FIGS. 15A-15D is used as the sensing device 100 of the fluorescence biosensing system 10 in FIG. 1. Specifically, a sample 100K is first disposed at the reaction area of the sensing device 100i. The sample 100K is an unbounded fluorescence probe, so that the sample 100K may tumble quickly in the sensing device 100i.

Referring to FIG. 16A, the excitation light 200ex is emitted to the sensing device 100i. The excitation light 200ex passes through the first upper sub-polarizer 152 and the second upper sub-polarizer 154 before reaching the sample 100K, so the excitation light 200ex in the sensing device 100i may be referred as the polarized excitation light 110ex having the first polarization direction. A portion of the polarized excitation light 110ex may pass through the reaction area and reach the lower polarizer 130. The portion of the polarized excitation light 110ex reaching the second lower sub-polarizer 134 is reflected by the second lower sub-polarizer 134. The portion of the polarized excitation light 110ex reaching the first lower sub-polarizer 132 passes through the first lower sub-polarizer 132 and is reflected by the excitation light rejection filter 190 below.

Referring to FIG. 16B, the sample 100K emits the emission lights 110em and 120em after absorbing the polarized excitation light 110ex. Since the sample 100K tumbles quickly in the sensing device 100i, the sample 100K emits the emission lights with various polarization directions. The emission light 110em having the first polarization direction may pass through the first lower sub-polarizer 132 and be detected by the first photodiode 122. The emission light 120em having the second polarization direction may pass through the second lower sub-polarizer 134 and be detected by the second photodiode 124. At this step, the intensity detected by the first photodiode 122 is close to the intensity detected by the second photodiode 124.

Referring to FIG. 16C, the sample 100L is added into the sensing device 100i. The sample 100K reacts with the sample 100L to form a bounded state molecule, leading to the slowly tumbling sample 100K in the sensing device 100i. After the reaction between the sample 100K and the sample 100L, the excitation light 200ex is emitted to the sensing device 100i again to obtain the polarized excitation light 110ex. Some of the polarized excitation light 110ex is absorbed by the bounded sample 100K, and some of the polarized excitation light 110ex is reflected by the second lower sub-polarizer 134 or the excitation light rejection filter 190.

Referring to FIG. 16D, the bounded sample 100K emits the emission lights 110em and 120em after absorbing the polarized excitation light 110ex. Since the bounded sample 100K tumbles slowly in the sensing device 100i, the bounded sample 100K emits the emission lights with specific polarization directions. As shown in FIG. 16D, the bonded sample 100K may prefer to emit the emission light 110em having the first polarization direction than the emission light 120em having the second polarization direction. As a result, the intensity detected by the first photodiode 122 below the first lower sub-polarizer 132 is higher than the intensity detected by the second photodiode 124 below the second lower sub-polarizer 134. Therefore, the fluorescence biosensing system including the sensing device 100i may be able to detect the sample 100L by using the sample 100K as a fluorescence probe.

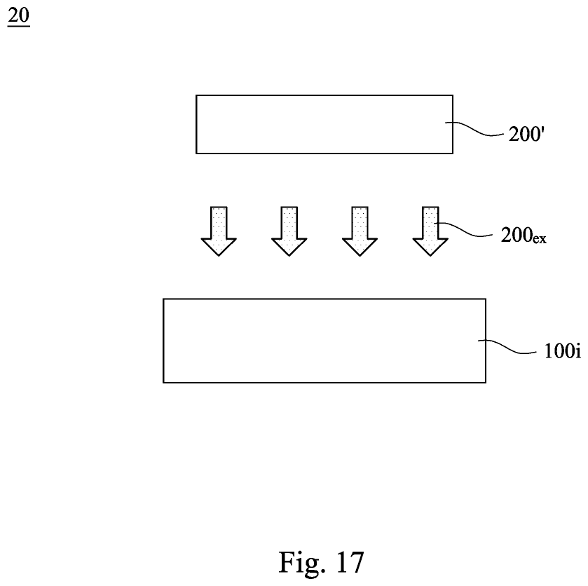

In the embodiments which the fluorescence biosensing system includes the sensing device 100i, the excitation light 200ex provided to the sensing device 100i may be non-polarized. For example, FIG. 17 illustrates a schematic view of a fluorescence biosensing system 20 including the sensing device 100i and a light emitting device 200′. When the non-polarized excitation light 200ex is emitted to the sensing device 100i by the light emitting device 200′, the upper polarizer 150 having the first polarization direction filters the non-polarized excitation light 200ex. As a result, the excitation light 200ex having the first polarization direction reaches the reaction area of the sensing device 100i.

According to the above-mentioned embodiments, the fluorescence biosensing system includes a sensing device and a light emitting device. The sensing device integrates a lower polarizer, a light transmitting element, and an upper polarizer together to provide some advantages. The light transmitting element is configured to refract the excitation light to the sample in the sensing device, which enhances the excitation light energy for the sample. The sub-polarizers of the lower polarizer and the upper polarizer have 90 degrees shifted polarization directions, which controls the light pathway to improve the accuracy of the fluorescence biosensing system. In addition, the integrated elements of the sensing device also provide two-step and one-step excitation for multiple fluorescence samples, which simplifies the biodetection method using the fluorescence biosensing system.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A fluorescence biosensing system, comprising:
a sensing device, comprising:
a sensing region;
a lower polarizer above the sensing region, wherein the lower polarizer comprises a first lower sub-polarizer and a second lower sub-polarizer, a second polarization direction of the second lower sub-polarizer is 90 degrees shifted from a first polarization direction of the first lower sub-polarizer;
a light transmitting element above the lower polarizer; and
an upper polarizer above the light transmitting element, wherein the upper polarizer comprises a first upper sub-polarizer aligned with the first lower sub-polarizer and a second upper sub-polarizer aligned with the second lower sub-polarizer; and
a light emitting device configured to provide an excitation light to the sensing device.

2. The fluorescence biosensing system of claim 1, wherein the first upper sub-polarizer has the first polarization direction, and the second upper sub-polarizer has the second polarization direction.

3. The fluorescence biosensing system of claim 1, wherein the first upper sub-polarizer and the second upper sub-polarizer have the first polarization direction.

4. The fluorescence biosensing system of claim 1, wherein the first lower sub-polarizer and the second lower sub-polarizer have different grating periods.

5. The fluorescence biosensing system of claim 1, wherein the sensing region comprises a photodiode overlapped by the first lower sub-polarizer and the second lower sub-polarizer.

6. The fluorescence biosensing system of claim 1, wherein the sensing region comprises a first photodiode overlapped by the first lower sub-polarizer and a second photodiode overlapped by the second lower sub-polarizer.

7. The fluorescence biosensing system of claim 1, wherein the sensing device further comprises:
a well extended from the upper polarizer into the light transmitting element, wherein a bottom surface of the well is a reaction area of the sensing device.

8. The fluorescence biosensing system of claim 7, wherein a portion of the light transmitting element is between the bottom surface of the well and the lower polarizer.

9. The fluorescence biosensing system of claim 7, wherein the light transmitting element is a micro lens or a prism configured to refract the excitation light toward the bottom surface of the well.

10. The fluorescence biosensing system of claim 1, wherein the upper polarizer is separated from the lower polarizer by the light transmitting element.

11. The fluorescence biosensing system of claim 1, wherein the sensing device further comprises:
a cover above the upper polarizer; and
an imaging medium filled between the cover and the upper polarizer.

12. The fluorescence biosensing system of claim 11, wherein a refractive index of the imaging medium is smaller than a refractive index of the light transmitting element.

13. The fluorescence biosensing system of claim 11, wherein a difference between a refractive index of the imaging medium and a refractive index of the light transmitting element is larger than 0.1.

14. The fluorescence biosensing system of claim 1, wherein the upper polarizer physically contacts the light transmitting element.

15. The fluorescence biosensing system of claim 1, wherein the sensing device further comprises:
a planarization layer between the light transmitting element and the upper polarizer, wherein a refractive index of the planarization layer is smaller than a refractive index of the light transmitting element.

16. The fluorescence biosensing system of claim 1, wherein the sensing device further comprises:
an excitation light rejection filter between the sensing region and the lower polarizer.

17. The fluorescence biosensing system of claim 1, wherein the light emitting device comprises:
a first light emitting unit configured to emit a first light having the first polarization direction;
a second light emitting unit configured to emit a second light having the second polarization direction; and
a dichroic mirror configured to combine the first light and the second light into the excitation light.

18. The fluorescence biosensing system of claim 17, wherein the first light emitting unit and the second light emitting unit are independently controlled.

19. The fluorescence biosensing system of claim 1, wherein the excitation light provided to the sensing device is non-polarized.

20. A biodetection method, comprising:
providing a fluorescence biosensing system comprising a sensing device and a light emitting device, wherein the sensing device comprises a first upper sub-polarizer aligned with a first lower sub-polarizer and a second upper sub-polarizer aligned with a second lower sub-polarizer;
disposing a sample at a reaction area of the sensing device;
emitting an excitation light to the first upper sub-polarizer and the second upper sub-polarizer by the light emitting device to obtain a polarized excitation light;
refracting the polarized excitation light toward the reaction area,
wherein a portion of the polarized excitation light passing through the first upper sub-polarizer reaches the second lower sub-polarizer;
reflecting the portion of the polarized excitation light out of the sensing device by the second lower sub-polarizer; and
detecting an emission light from the sample by the sensing device.
